(19) United States
(12) Patent Application Publication
(10) Pub. No.: US 2024/0231964 A1
(43) Pub. Date: Jul. 11, 2024

(54) PROPAGATING REQUESTS TO DELETE SIGNALS THAT CROSS PARTITION BOUNDARIES

(71) Applicant: Microsoft Technology Licensing, LLC, Redmond, WA (US)

(72) Inventors: Bo LIU, Sammamish, WA (US); Julio Novais da Fonseca, São Paulo/SP (BR); Sharanya KRISHNAN, Redmond, WA (US); Víctor Macêdo ALEXANDRINO, São Paulo (BR); Fellipe Rego, São Caetano Do Sul (BR)

(21) Appl. No.: 18/151,082

(22) Filed: Jan. 6, 2023

(51) Int. Cl. G06F 9/54

(52) U.S. Cl. CPC G06F 9/544

(57) ABSTRACT

A signal propagation system populates a participant table in individual partitions. The participant table identifies signals that have been propagated to other partitions, as well as a target identifier that identifies the partition to which the signal was propagated. A deletion application programming interface (API) receives a deletion request to delete a signal. The deletion API accesses the participant table to identify partitions to which the signal was propagated. The deletion API propagates the deletion request to other partitions identified in the participant table.

### BACKGROUND

Computing systems are currently in wide use. Many computing systems host applications that are accessed by users or clients. Such applications often store user data and allow users to manipulate user data.

In addition, some computing systems partition data and other resources into partitions and store user data in those partitions.

The discussion above is merely provided for general background information and is not intended to be used as an aid in determining the scope of the claimed subject matter.

### SUMMARY

A signal propagation system populates a propagation table in a partition. The propagation table identifies an item of information that has been propagated to another partition, as well as a target identifier that identifies the partition to which the item of information was propagated. A deletion application programming interface (API) receives a deletion request to delete the item of information. The deletion API accesses the propagation table to identify the partition to which the item of information was propagated. The deletion API propagates the deletion request to the partition identified in the propagation table.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a data flow diagram showing propagation of a deletion request.

FIG. 3 is a data flow diagram showing the aggregation of deletion results.

FIG. 4 shows a flow diagram illustrating one example of the operation of the architecture illustrated in FIGS. 1-3.

FIG. 5 is a block diagram showing the architecture illustrated in the previous figures, deployed in a remote server architecture.

FIG. 6 is a block diagram of one example of a computing environment that can be used in the architectures and systems shown in previous figures.

### DETAILED DESCRIPTION

As discussed above, some computing systems divide resources (such as memory, etc.) into computing system partitions and store user data in the partitions. A signal collection system, which can be a service, collects user signals (items of information) across multiple applications. The signals can include sensitive customer data, and therefore the signals are to be compliant with data management regulations or data protection regulations. Therefore, the data must normally be deleted within a specified amount of time of when the owner of the data requests its deletion.

However, there are many scenarios in which the data signals cross partition boundaries. In some current systems, in order to perform deletions of signals that have been propagated across partition boundaries, a deletion algorithm is intermittently scheduled and run. The deletion algorithm identifies signals that are out of date or are otherwise identified as signals to be deleted. However, using the intermittent deletion algorithms means that it may take an undesirably long amount of time to accomplish a desired deletion. It can also be difficult to verify when such deletions were actually performed.

The present discussion thus proceeds with respect to a system that maintains a propagation table in each partition. The propagation table identifies when one or more signals have been propagated to a different partition, and also identifies the signals that were propagated and the partition to which the signals are propagated. Then, when a deletion command is received to delete a signal that was propagated, the deletion command can be propagated to the same partitions where the signal was propagated, in order to perform a deletion operation on those partitions as well.

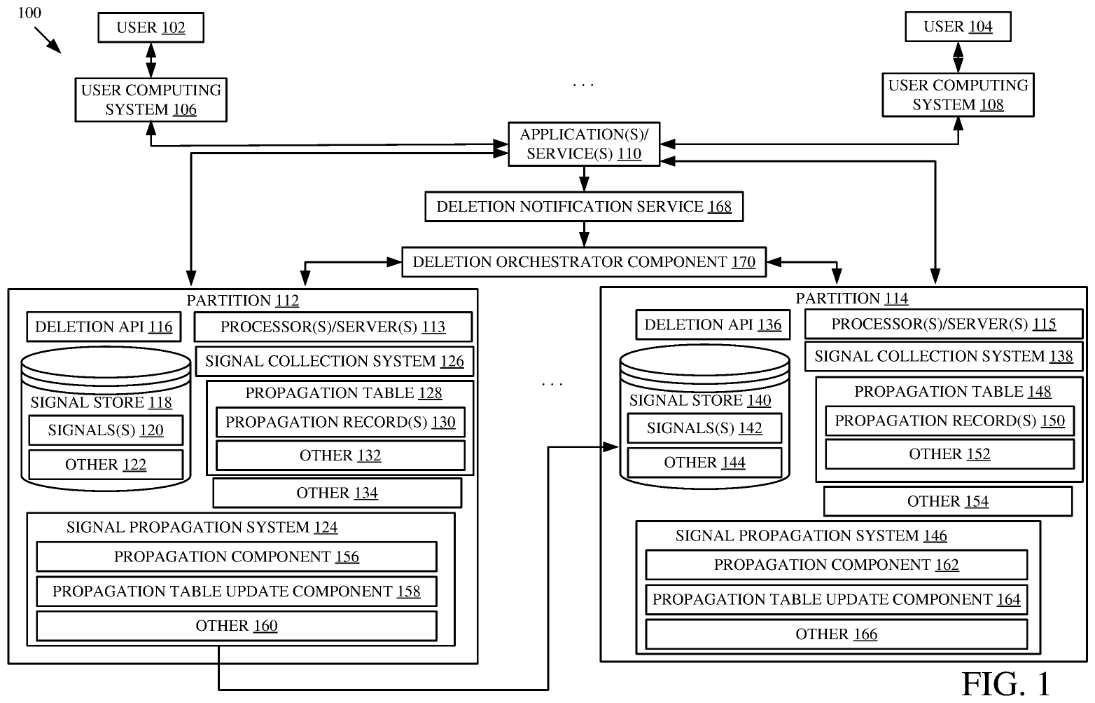

FIG. 1 is a block diagram of one example of a computing system architecture 100. In the example shown in FIG. 1, architecture 100 shows that users 102-104 can use user computing systems 106-108 to access hosted applications or services 110. The applications or services 110 can be used by the users 102-104 to manipulate user data that is stored in computing system partitions 112-114. Partitions 112 -114 include resources that store data corresponding to the different users 102-104, respectively. In the example shown in FIG. 1. partition 112 includes one or more processors or servers 113, a deletion application programming interface (API) 116, signal store 118 (which stores signals 120 and other items 122), signal propagation system 124, signal collection system 126, propagation table 128 (which stores propagation records 130 and other items 132) as well as other items 134. Signal propagation system 124 includes propagation component 156, propagation table update component 158, and other items 160.

Partition 114 also includes one or more processors or servers 115, deletion API 136, signal collection system 138, signal store 140 (which includes signals 142 and other items 144), signal propagation system 146, propagation table 148 (which includes propagation records 150 and other items 152), as well as other items 154.

Signal propagation system 146 includes propagation component 162, propagation table update component 164, and other items 166.

Architecture 100 also includes deletion notification service 168 and deletion orchestration component 170. Before describing the overall operation of architecture 100 in more detail, a description of some of the items in architecture 100, and their operation, will first be provided.

User computing system 106 can include processors and/or servers and can be a user or tenant computing system that allows user 102 to use applications and/or services 110. Applications and/or services 110 may be hosted services that, themselves, include processors or servers and other infrastructure for hosting the applications and/or services 110. The application/services 110 allow user 102 to access and manipulate user data. The user data can be any of a wide variety of different types of user data and may be stored in partition 112. The data may be represented by signals 120 which are items of information that are stored in signal store 118. Similarly, user 104 uses user computing system 108 to access applications/services 110 in order to manipulate user data that is represented by signals 142 stored in signal store 140 in partition 114.

The signals, which represent the user data, and how the users interact with that user data, can be collected by signal collection systems 126 and 138. Systems 126 and 138 may be partition-based platform services that collect the user data and manipulations and store them in the corresponding signal stores 118 and 140.

There are a wide variety of different types of scenarios where the user data represented by the signals is propagated across partition boundaries. For instance, assume that application/services 110 provide file collaboration services. In such an example, user 102 may share a file with user 104, and user 104 may later open and edit that file. In that scenario, a signal indicating that the file has been accessed and modified is created by signal collection system 138 in partition 114 and stored in signal store 140. Propagation component 162 in signal propagation system 146 then propagates that signal to partition 112 where it is also stored in signal store 118.

In another scenario, assume that applications/services 110 include an instant messaging service in which user 102 comments on a message received from user 104. By way of example, assume that user 102 provides an input to “like” an instant message sent by user 104. In that case, signal collection system 126 collects the signal indicative of the comment on the instant message and stores that signal in signal store 118. Similarly, propagation component 156 propagates that signal to partition 114 where signal collection system 138 stores it in signal store 140.

Deleting and tracking deletion of these types of information can be difficult, especially where the information is propagated across partition boundaries. For instance, assume that user 102 now provides an input command to delete the comment on the message sent by user 104. In that case, it can be difficult to delete the signal corresponding to the comment in all locations, because it is not only stored as a signal 120 in signal store 118, but it has also been propagated to partition 114.

Therefore, in accordance with one example, the present system includes propagation table 128 in partition 112, along with propagation table update component 158. The present system also includes propagation table 148 in partition 114, as well as propagation table update component 164.

Propagation table 128 stores propagation records 130 that identify signals that have been propagated to a different partition. The propagation records 130 can include a signal identifier that identifies the signal that was propagated, a target partition identifier that identifies the partition to which the signal was propagated, a time indicator indicating when the signal was propagated, and/or other items. Propagation table update component 158 receives an indication from propagation component 156 that a signal is being propagated to a different partition. In response, propagation table update component 158 updates the propagation table 128 to add a propagation record 130 identifying that particular propagation.

Similarly, when a signal is propagated out of partition 114, then propagation component 162 provides an indication of this to propagation table update component 164. Component 164 updates propagation table 148 in partition 114 to include a propagation record 150 that identifies the propagation (e.g., the signal identifier, the target partition identifier, the propagation time, etc.).

Therefore, when a deletion request is received, such as (in the previous example) when user 102 provides a request to application/services 110 to delete the comment on the instant message received from user 104, then deletion notification service 168 receives an output from application/services 110 indicating that the deletion request has been received. Deletion notification service 168 generates a notification to deletion orchestrator component 170. Deletion orchestrator component 170 provides a deletion command to partition 112. In one example, deletion orchestrator component 170 calls deletion API 116 with the deletion command. Deletion API 116 not only deletes the corresponding signal from signal store 118, but accesses propagation table 128 to determine whether the signal to be deleted has been propagated to any other partitions. If so, then deletion API 116 propagates the deletion request to the other partitions to which the signal was propagated.

The deletion results (e.g., status of the deletion request) can be aggregated either by deletion API 116 or deletion orchestrator component 170 and provided to deletion notification service 168. Deletion notification service 168 can provide the aggregated deletion results to the application/service 110 that requested the deletion. Thus, the deletion operation is asynchronous in that applications/services 110 need not wait for the deletion to be accomplished, in order to continue operation. Similarly, however, the deletions are proactively made in all partitions 112-114 so that they are made more quickly after receiving a deletion request than in prior systems where a deletion algorithm was intermittently run to delete signals that were out of date.

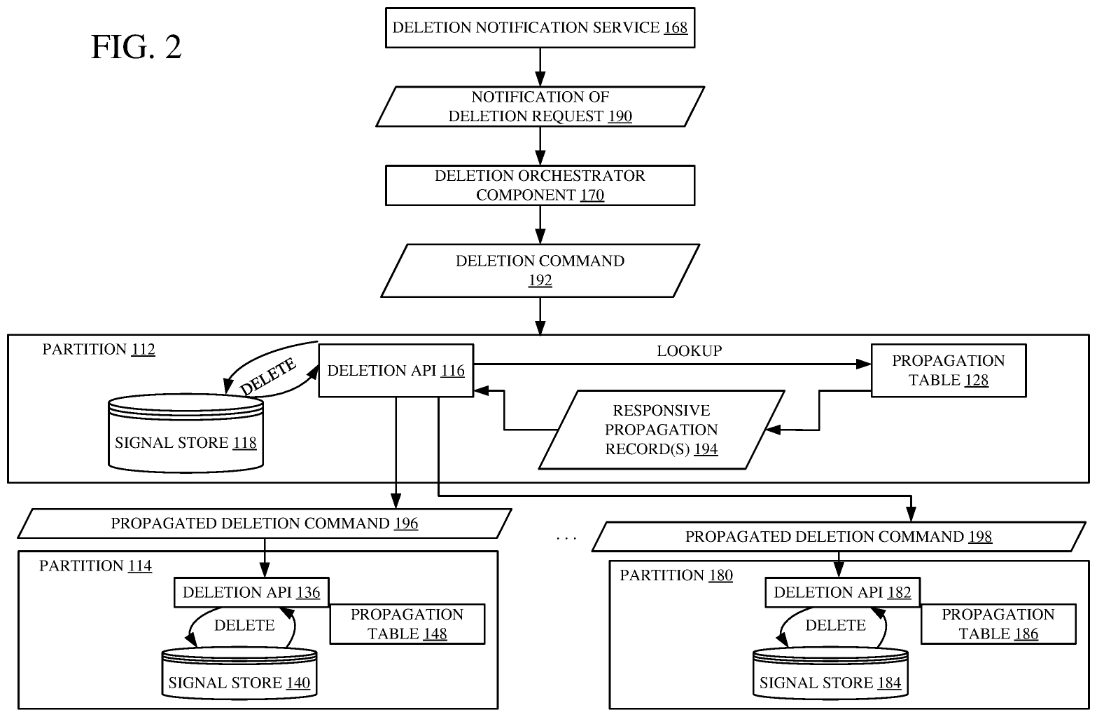

FIG. 2 is a data flow diagram illustrating how a delete command is propagated to a plurality of different partitions. Some of the items in FIG. 2 are similar to those shown in FIG. 1, and they are similarly numbered. In the example shown in FIG. 2, an additional partition 180 is shown. Partition 180 is similar to partitions 112 and 114 and thus exposes a deletion API 182 and also has a signal store 184, propagation table 186, and other items that are similar to those in partitions 112 and 114 and described above with respect to FIG. 1. It is assumed for the sake of the example shown in FIG. 2 that deletion notification service 168 receives an input from an application/service 110 that a user (e.g., user 102) or the corresponding user computing system 106 has provided a delete command. In response, deletion notification service 168 generates a notification 190 of the deletion request and provides the notification 190 to deletion orchestrator component 170. Deletion orchestrator component 170 identifies the particular partition 112 where the information to be deleted is stored and calls the deletion command method on deletion API 116, with the deletion command 192. In response, deletion API 116 not only deletes the signal from signal store 118, but also performs a lookup in propagation table 128 to identify any propagation records corresponding to the signal to be deleted, to determine whether that signal has been propagated to other partitions.

The propagation records 194 that are responsive to the lookup are returned to deletion API 116. The responsive propagation records 194 identify the target partitions where the signal has been propagated. For purposes of the present discussion, it is assumed that the signal to be deleted has been propagated to partition 114 and partition 180, and the responsive propagation records 194 indicate this.

Deletion API 116 then generates propagated deletion commands 196 and 198, thus propagating the deletion command 192 to the target partitions 114 and 180 to which the signal was propagated. In one example, deletion API 116 calls the deletion APIs 136 and 182 with the propagated deletion commands 196 and 198, identifying the signal to be deleted on partitions 114 and 180, respectively. Deletion API 136 then deletes the signal from signal store 140 and deletion API 182 deletes the signal from signal store 184.

It will be noted that the deletion API 136 can also perform a lookup in propagation table 148 to determine whether the signal was propagated further to other partitions, from partition 114. Similarly, deletion API 182 can perform a lookup in propagation table 186 to determine whether the signal was propagated beyond partition 180 to other partitions. FIG. 2 thus shows how a deletion command is propagated to other partitions where the signal to be deleted has been propagated.

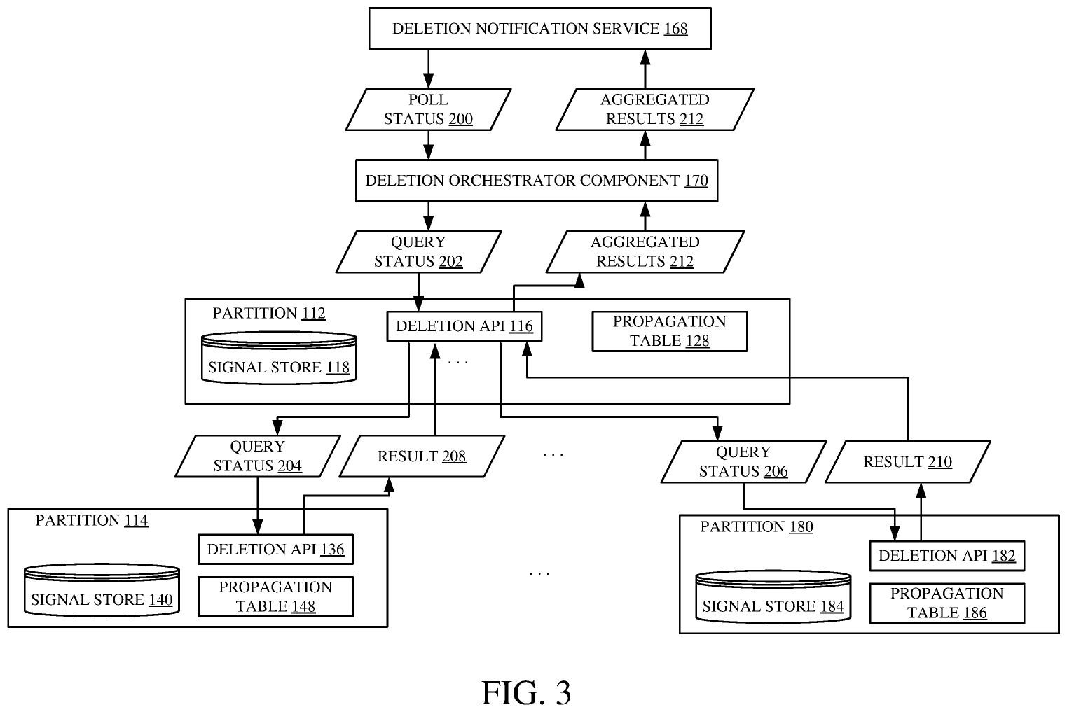

FIG. 3 is a data flow diagram that shows some items which are similar to those shown in FIG. 2, and they are similarly numbered. However, FIG. 3 shows how the deletion status of the signal to be deleted is communicated back to deletion notification service 168.

After deletion notification service 168 sends the notification 190 of the deletion request (shown in FIG. 2) to deletion orchestrator component 170, deletion notification service 168 can poll the status of the deletion request on deletion orchestrator component 170, as indicated by a poll status request 200 in FIG. 3. Deletion orchestrator component 170 then calls deletion API 116 with a status request query 202, requesting the status of the deletion request. In response, deletion API 116 sends status queries 204-206 to the partitions 114 and 180 to which the delete command was propagated. Deletion APIs 136 and 182, in response, return the results 208-210 showing the status of the deletion commands. The results 208-210 can be returned to deletion orchestrator component 170 or through deletion API 116.

When deletion API 116 sends status queries 204-206, then deletion API 116 generates aggregated results 212, which are returned to deletion orchestrator component 170. The aggregated results identify the status of the deletion command in partition 112, and the other partitions 114 and 180 to which the deletion command was propagated. When the status queries 204-206 are provided directly from deletion orchestrator component 170, then results 208-210 can be returned to deletion orchestrator component 170. In either case, deletion orchestrator component 170 illustratively returns the aggregated results 212 to deletion notification service 168, which can, in turn, return them to the applications/services 110.

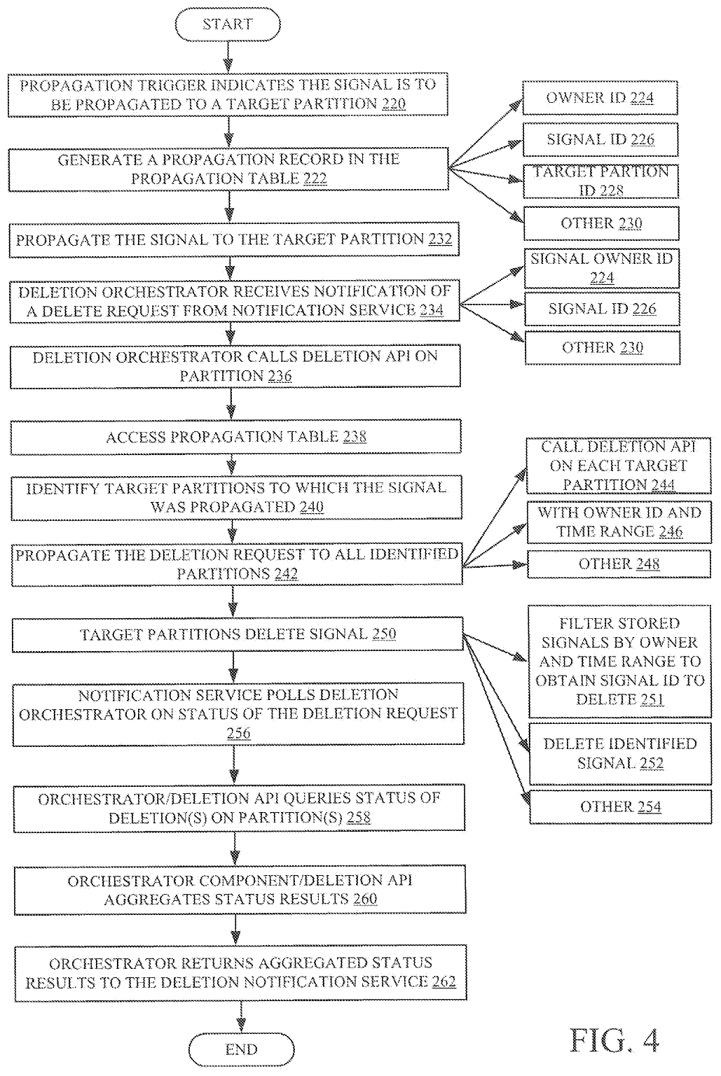

FIG. 4 shows a flow diagram illustrating one example of the operation of architecture 100 in propagating a deletion command and returning the aggregated results of the deletion command. It is assumed that signal propagation system 124 receives a propagation trigger indicating that a signal is to be propagated to a target partition, as indicated by block 220. For instance, assume that propagation component 156 receives an indication that a particular signal 120 is to be propagated from partition 112 to partition 114. This may be indicated in one of the scenarios mentioned above, or in a wide variety of other scenarios.

Propagation table update component 158 then generates a propagation record 130 in the propagation table 120 of partition 112, as indicated by block 222 in the flow diagram of FIG. 4. The propagation record 130 can include any of a wide variety of information, such as an owner identifier 224 that identifies the owner of the signal that is to be propagated, a signal identifier 226 that identifies the signal to be propagated, a target partition identifier 228 that identifies the partition 140 to which the signal is to be propagated, and any of a wide variety of other information 230, as well. The propagation component 156 also propagates the signal to the target partition, as indicated by block 232 in the flow diagram of FIG. 4.

At some point, deletion orchestrator component 170 receives a notification of a deletion request 190 from deletion notification service 168. Receiving the notification is indicated by block 234 in the flow diagram of FIG. 4. The notification may include the signal owner identifier ID 224 that identifies the owner of the signal (such as who created it), the signal identifier ID 226 that identifies the signal, and other information 228. Deletion orchestrator component 170 then calls the deletion API 116 on the partition 112 corresponding to the owner of the signal to be deleted. Calling the deletion API 116 is indicated by block 236 in the flow diagram of FIG. 4.

In response, the deletion API 116 accesses the propagation table 128 and identifies any target partitions to which the signal was propagated. Accessing the propagation table 128 is indicated by block 238 in the flow diagram of FIG. 4, and identifying target partitions to which the signal was propagated is indicated by block 240.

The deletion request (or deletion command) is then propagated to all of the identified target partitions, as indicated by block 242. Propagating the deletion request (or command) can be done by calling the deletion APIs 136 and 182 on each of the identified target partitions, as indicated by block 244. The call on the deletion APIs 136 and 182 on the target partitions may include the owner ID, the signal ID, and a time range during which the signal was propagated, as indicated by block 246. The propagation of the deletion request to the identified target partitions can be done in other ways as well, as indicated by block 248.

Each of the identified target partitions 114 and 180 then delete the signal from the corresponding signal stores 140 and 184, as indicated by block 250 in the flow diagram of FIG. 4. In one example, the signals in the signal stores 140 and 184 can be filtered using the owner ID and time range, to more quickly obtain the signal identifiers of the signals to be deleted in the signal stores 140 and 184. Filtering the signals to identify the signal IDs to be deleted is indicated by block 251 in the flow diagram of FIG. 4. The identified signals are then deleted, as indicated by block 252. The target partitions can delete the signals in other ways as well, as indicated by block 254.

At some point, the deletion notification service 168 polls the deletion orchestrator component 170 in an effort to identify the status of the deletion request. Polling the deletion orchestrator component 170 is indicated by block 256 in the flow diagram of FIG. 4. The orchestrator component 170 can then query the partitions to which the deletion command or request was sent, by calling the deletion APIs on those partitions. In another example, the deletion orchestrator component 170 calls the deletion API 116 on the partition 112 corresponding to the owner of the signal, and that deletion API 116, itself, calls the deletion APIs 236 and 182 exposed by the partitions 114 and 180 to which the signal is propagated. Having the orchestrator component 170 and/or the deletion API 116 query the status of the deletions on the partitions to which the deletion command was propagated is indicated by block 258 in the flow diagram of FIG. 4. The deletion status results are then returned to the deletion orchestration component 170 and the aggregated results 212 are returned to the deletion notification service 168. Aggregating the status results is indicated by block 260, and returning the aggregated status results 212 to the deletion notification service is indicated by block 262.

It can thus be seen that the present discussion describes a system in which a propagation table is maintained in each partition where data is stored. The propagation table is updated as data or signals are propagated to other partitions. Therefore, when a delete command or delete request is received for an item of data or signal, the propagation table is accessed and the delete command or delete request is propagated to the other partitions to which the item of data or signal was also propagated. Results of the delete request or delete command can be aggregated from the various partitions and returned back to the notification system and/or application or service which issued the delete command or delete request. This allows the items of data or signals to be deleted in a more timely manner than in other systems.

It will be noted that the above discussion has described a variety of different systems, components, services, and/or logic. It will be appreciated that such systems, components, services, and/or logic can be comprised of hardware items (such as processors and associated memory, or other processing components, some of which are described below) that perform the functions associated with those systems, components, services, and/or logic. In addition, the systems, components, services, and/or logic can be comprised of software that is loaded into a memory and is subsequently executed by a processor or server, or other computing component, as described below. The systems, components, services, and/or logic can also be comprised of different combinations of hardware, software, firmware, etc., some examples of which are described below. These are only some examples of different structures that can be used to form the systems, components, services, and/or logic described above. Other structures can be used as well.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of the other components or items in those systems.

Also, a number of user interface (UI) displays have been discussed. The US displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, they can be actuated using touch gestures. Also, where the device that displays them has speech recognition components, they can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

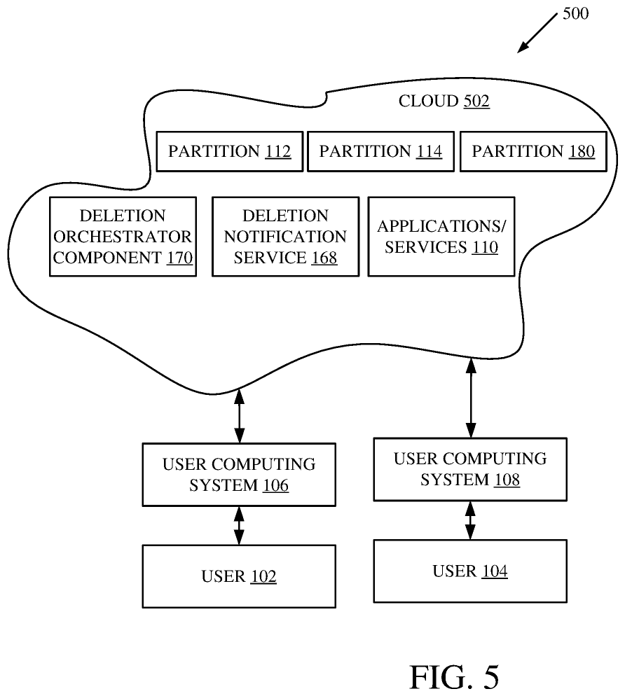

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, the components and functions can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in FIG. 1 and they are similarly numbered. FIG. 5 specifically shows that applications/services 110, deletion notification service 168, component 170, and partitions 112, 114, and 180 can be located in cloud 502 (which can be public, private, or a combination where portions are public while others are private). Therefore, users 102-104 use user computing systems 106-108 to access those systems through cloud 502.

Regardless of where they are located, the items can be accessed directly by systems 106-108, through a network (either a wide area network or a local area network), the items can be hosted at a remote site by a service, or the items can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

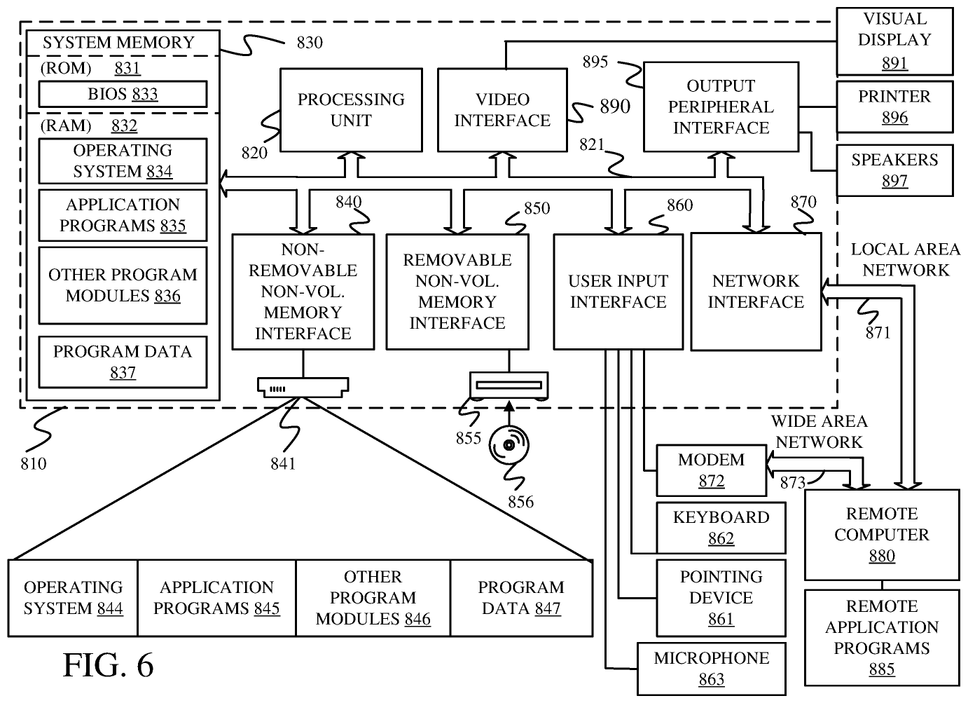

FIG. 6 is one example of a computing environment in which architecture 100, or parts of it, (for example) can be deployed. With reference to FIG. 6, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 6.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 6 illustrates operating system 834, application programs 835, other program modules 836, and program data 837.

The computer 810 may also include other removable/non-removable volatile/nonvolatile computer storage media. By way of example only, FIG. 6 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 is typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 6, provide storage of computer readable instructions, data structures, program modules and other data for the computer 810. In FIG. 6, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 6 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 6 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
receiving a deletion request at a first computing system partition that stores data for a first user, the deletion request identifying an item of information to be deleted from the first computing system partition;
accessing a propagation table in the first computing system partition, that stores a propagation record, to determine that the item of information has been propagated to a second computing system partition based on the propagation record; and
propagating the deletion request to the second computing system partition.

2. The computer implemented method of claim 1 wherein receiving the deletion request at the first computing system partition comprises:
exposing a first deletion application programming interface (API) on the first computing system partition; and
receiving a call on a deletion method of the first deletion API.

3. The computer implemented method of claim 2 and further comprising:
deleting the item of information from the first computing system partition using the deletion API.

4. The computer implemented method of claim 2 wherein propagating the deletion request to the second computing system partition comprises:
exposing a second deletion API on the second computing system partition; and
calling a deletion method on the second deletion API.

5. The computer system of claim 1 and further comprising:
accessing a propagation table in the second computing system partition to determine whether the item of data was propagated to a third computing system partition; and
if so, propagating the deletion request to the third computing system partition.

6. The computer implemented method of claim 1 wherein accessing the propagation table in the first computing system partition comprises:
identifying the propagation record as identifying propagation of the item of information; and
determining from the propagation record that the item of information has been propagated to the second computing system partition.

7. The computer implemented method of claim 1 and further comprising:
detecting the propagation of the item of information to the second computing system partition; and
generating a propagation record in the propagation table in the first computing system partition indicative of the propagation of the item of information to the second computing system partition.

8. The computer implemented method of claim 1 and further comprising:
receiving at the first deletion API a deletion status request; and
providing a deletion status response indicative of a status of the deletion request on the first computing system partition.

9. The computer implemented method of claim 8 wherein providing a deletion status response comprises:
aggregating deletion status results from the first computing system partition and the second computing system partition; and
providing the aggregated deletion status results as the deletion status response.

10. A computer system, comprising:
a first computing system that stores data for a first user;
a deletion application programming interface (API) exposed by the first computing system partition;
a propagation component that propagates an item of information from the first computing system partition to a second computing system partition;
a propagation table; and
a propagation table update component that generates a propagation record in the propagation table, the propagation record being indicative of the propagation of the item of information to the second computing system partition.

11. The computer system of claim 10 wherein the deletion API is configured to receive a deletion request to delete the item of information, to delete the item of information from the first computing system partition, and to access the propagation table to identify, from the propagation record, that the item of information has been propagated to the second computing system partition.

12. The computer system of claim 11 wherein the deletion API is configured to, in response to identifying from the propagation record that the item of information has been propagated to the second computing system partition, propagate the deletion request to the second computing system partition.

13. The computer system of claim 12 wherein the deletion API is configured to receive a deletion status request, aggregate deletion status results from the first computing system partition and the second computing system partition, and provide the aggregated deletion status results in response to the deletion status request.

14. The computer system of claim 10 wherein the propagation table update component is configured to generate the propagation record including an item identifier identifying the item of information and a target partition identifier identifying the computing system partition to which the item of information is propagated.

15. A computer system, comprising:
at least one processor; and
a data store storing computer executable instructions which, when executed by the at least one processor, causes the at least one processor to perform steps, comprising:
receiving a deletion request at a first computing system partition that stores data for a first user, the deletion request identifying an item of information to be deleted from the first computing system partition;
accessing a propagation table in the first computing system partition, that stores a propagation record, to determine that the item of information has been propagated to a second computing system partition based on the propagation record; and
propagating the deletion request to the second computing system partition.

16. The computer system of claim 15 wherein the steps further comprise:
detecting the propagation of the item of information to the second computing system partition; and
generating a propagation record in a propagation table in the first computing system partition, the propagation record being indicative of the propagation of the item of information to the second computing system partition.

17. The computer system of claim 15 wherein the steps further comprise:
exposing a first deletion application programming interface (API) on the first computing system partition;
receiving at the first deletion API a deletion status request; and
providing a deletion status response indicative of a status of the deletion request on the first computing system partition.

18. The computer system of claim 17 wherein providing a deletion status response comprises:
aggregating deletion status results from the first computing system partition and the second computing system partition; and
providing the aggregated deletion status results as the deletion status response.

19. The computer system of claim 17 wherein the steps further comprise:
deleting the item of information from the first computing system partition using the first deletion APL

20. The computer system of claim 17 wherein propagating the deletion request to the second computing system partition comprises:
exposing a second deletion API on the second computing system partition; and
calling a deletion method on the second deletion APL
